(19) United States
(12) Patent Application Publication
(10) Pub. No.: US 2007/0029124 A1
(43) Pub. Date: Feb. 8, 2007

(54) Battery powered vehicle overvoltage protection circuitry

(76) Inventors: Sankar DasGupta, Mississauga (CA); Rakesh Bhola, Mississauga (CA)

Correspondence Address: David B. Woycechowsky;ELECTROVAYA Patent Department, 2645 Royal Windsor Drive, Mississauga, ON, L5J 1K9, CA

(21) Appl. No.: 11/434,586

(22) Filed: May 16, 2006

Related U.S. Application Data
(60) Provisional application No. 60/686,413, filed on Jun. 2, 2005.

(51) Int. Cl. B60L 11/18; H01M 16/00; H01M 10/40

(52) U.S. Cl. 180/65.3; 429/9; 429/231.95

(57) ABSTRACT

Battery system with multiple electrochemical cell types, wherein one cell type(s) (e.g., aqueous electrochemical cells) provides overvoltage protection for other cell type(s) (e.g., lithium ion superpolymer electrochemical cells). Battery system for a BPV with interchangeable modules of two or more 1:1 replaceable types, wherein each type of module has a different type, or combination, of electrochemical cells. For example, one battery module type may contain aqueous cells suitable for overvoltage protection and high power operation, while another battery module may include lithium ion superpolymer cells for their large capacity and high energy density. Use of lithium ion superpolymer electrochemical cells in low speed battery powered vehicles.

### RELATED APPLICATION DATA

This application claims any and all applicable benefits based on the following provisional patent application(s): (1) U.S. patent application No. 60/618,087 filed on 16 May 2005; and (2) U.S. patent application No. 60/686,413 filed on 2 Jun. 2005. All of the foregoing patent-related documents are herein incorporated by reference.

### FIELD OF THE INVENTION

The present invention relates to electric battery systems for power storage and more particularly to electric battery systems for battery powered vehicles (“BPVs,” see DEFINITIONS section for a definition) and even more particularly to electric battery systems for low speed battery powered vehicles (“LSBPVs,” see DEFINITIONS section for a definition).

### DESCRIPTION OF THE RELATED ART

BPVs are conventional. One BPV design is shown in U.S. Pat. No. 6,331,365 (“'365 King”) at FIG. 7. The BPV of FIG. 7 of '365 King includes a lithium ion, high energy density energy battery and a high power density power battery (e.g., Nickel-Cadmium, lead-acid). Both the energy battery and the power battery can supply energy to drive the BPV's electric motor. The power battery preferably provides electrical energy for a high power response for acceleration of the BPV or heavy load conditions. The energy battery stores and provides electrical energy to give the BPV of FIG. 7 of '365 King extended range of operation.

The BPV of FIG. 7 of King recaptures electrical energy by using an electric motor with a regenerative braking feature. Specifically, the burst of regenerative braking electrical energy is directed by the power circuitry to charge the power battery. King also discloses that an (optional) dynamic retarder may be used to help limit the regenerative energy burst somewhat. In this way, the energy burst can be more reliably accommodated by the power battery. However, neither the regenerative energy, nor other electrical energy stored in the power battery can charge the energy battery. Rather, the BPV of FIG. 7 of '365 King uses a boost converter, including a unidirectional conductor, to ensure that no electrical energy from the power circuitry ever recharges the energy battery. This approach has its advantages and disadvantages. It is advantageous to shield the energy battery from incoming electrical energy bursts using the unidirectional conductor. Specifically, the one way conductor prevents overvoltage that would damage the energy battery. However, this means that the energy battery must be charged from elsewhere, presumably only from external, stationary charging sources designed to interface with the '365 King BPV. This prohibition of recharging the energy battery during BPV operation is a disadvantage and probably limits energy efficiency and reduces driving range of the FIG. 7 '365 King BPV. Also, the prohibition on recharging the energy battery might be disadvantageous from a cell charging / discharging equalization perspective.

Finally, with respect to the FIG. 7 embodiment of '365 King, it is noted that the voltage across the energy battery is different than the voltage across the power battery. This disparity in electrical potential necessitates the use of the boost converter to boost the voltage level of the energy battery. The use of this boost converter apparently allows the electrochemical cells of the FIG. 7 '365 energy battery to be connected in parallel, but it also necessitates the additional expense, complexity and additional possibility of circuit failure caused by the addition of the boost converter to the power circuitry.

U.S. Pat. No. 6,441,581 (“'581 King”) discloses a battery energy storage system for an electric locomotive. '581 King discloses that the battery energy storage system is “intended to include one or more types of conventional batteries such as lead acid, nickel cadmium, nickel metal hydride, and lithium ion batteries, for example, as well as other types of electrically rechargeable devices such as high specific power ultracapacitors, for example.”U.S. Published Patent Application publication number 2002/0145404 (“'404 DasGupta,” hereby incorporated by reference in its entirety) discloses a battery system for a BPV. The battery system has an energy battery connected to a power battery. The energy battery has a higher energy density than the power battery. However, the power battery can provide electrical power to the electrical motor at different power rates, thereby ensuring that the motor has sufficient power and current when needed. The battery system also includes a controller for coordinating, charging and working of the energy battery, as well as the power battery. The controller also coordinates the charging and working of the energy battery and the power battery in order to preserve longevity of both, such as by preventing overcharging of the power battery and overheating of the energy battery.

A still further advantage of the '404 DasGupta BPV is that, because a lead-acid battery is utilized, existing energy recovery techniques can be used. '404 DasGupta goes on to disclose the following: “In particular, the energy generated during braking can be harnessed for replenishing the energy level of the lead-acid battery when the vehicle is brought to a stop. This procedure is often referred to as regenerative braking. Just as certain loads require occasional or periodic bursts of energy, some charging sources can make available bursts of energy from time to time. The regenerative braking of a vehicle is an example of such a ‘burst-type’ charging source. If the energy storage device is capable of accepting charge at a high rate, these bursts of energy can be efficiently accepted. An advantage of the present invention is that occasional or periodic bursts of power can be used to rapidly recharge the power battery at a rate that may not be accepted efficiently by the energy battery, or, could damage the energy battery. A subsequent heavy load might use the energy from this ‘burst type’ charging source directly from the power battery. Alternately, the power battery might be used to recharge the energy battery at a lower rate over a longer period of time. Which routing of energy is most effective in any particular use will of course vary with the time-dependent energy needs of the electrical load and the particular application of the energy storage device.”

U.S. Published Patent Application publication number 2004/0201365 (“'365 DasGupta,”hereby incorporated by reference in its entirety) discloses a battery system for a BPV. '365 DasGupta is a continuation-in-part application (“C-I-P application”) of the '404 DasGupta application discussed above. The BPV energy storage system of '365 DasGupta is shown at FIG. 1. '365 DasGupta discloses: “In a further preferred embodiment, the controller utilizes 'inherent control'to control the flow of electrical energy between the batteries and the load, such as the motor. In this embodiment, the controller may initially operate to place the power battery in parallel with the energy battery. Furthermore, in this embodiment, the controller may place both batteries in parallel with the motor. . . . In a preferred embodiment, the power battery and the energy battery are in parallel, and because of this, it is possible for the motor to draw current from both simultaneously, in certain circumstances. Furthermore, the voltage of the two batteries would be the same in that they are connected in parallel

Concerning inherent battery control, '365 DasGupta discloses that: “The general impedance for an aqueous battery, such as a lead acid cell, will be generally 10% of the general impedance of a non-aqueous battery such as a lithium ion cell. The term “total impedance” as used in the present context refers to the impedance of the entire battery, including all of the cells, rather than the general impedance of a single cell. Thus, if a smaller lead acid power battery as compared to the lithium ion battery is used, then the total impedance of the smaller power battery may rise and the total impedance of the larger lithium ion energy battery will decrease. . . . Because the power battery will generally have a lower total impedance, the power battery would more readily provide power to the motor than the energy battery. Because of this, the power battery will generally become discharged faster. This will result in the energy battery substantially continuously recharging the power battery. . . . In order to facilitate this arrangement, it is preferred that the batteries are arranged such that the total voltage across all of the cells is nominally approximately equal. In this way, provided the batteries do not go below a critical voltage, the voltage across the two batteries would be equal.”

Concerning impedances designed for inherent battery control, '365 DasGupta discloses that: “In this embodiment, and provided the batteries remain in parallel with each other, the flow of electrical power, and, the currents and voltages will be inherently controlled . . . In a preferred embodiment, to facilitate inherent control, the total impedance of the power battery will be 10% to 60% the total impedance of the energy battery. More preferably, the total impedance of power battery is in the range of 35% to 50% and still more preferably, about 40%. This ratio of total impedance for the batteries has been found to give the best inherent control of the energy and power batteries and in particular lithium ion energy batteries and lead acid power batteries. Because the power battery would have a lower energy density, it would also generally have a lower total impedance, so that the power battery will generally supply a larger current, particularly-when there is a large demand placed on the batteries by the motor. Furthermore, when a large demand occurs, additional electrical power and current from the energy battery would go towards satisfying the requirement of the motor. This would occur inherently because of the inherent characteristics of the batteries, such as the current and voltage at which they can supply electrical power, as well as the inherent general impedance of the cells and the total impedance of the batteries, which is also a function of the ability of the batteries to supply voltage and current.”(Fig.-related reference numerals omitted from the foregoing quotations).

LSBPVs are also conventional, but conventional LSBPVs use lead-acid electrochemical cells and do not generally utilize lithium ion superpolymer electrochemical cells. The definitions section herein sets forth a definition for LSBPVs based primarily on top speed of the vehicle. Under the broad definition of LSBPVs controlling herein, there are many different kinds of LSBPVs with various features. Some of the pertinent features that differentiate various types or categories of LSBPVs, besides top speed, are vehicle mass; vehicle housing type (e.g., golf cart, Rascal type vehicle, motorized wheelchair, motor scooter, Segway type scooter, motorized skateboard); vehicle drive system (e.g., 4 wheels, 2 wheels, endless track drive, small rail vehicle, vehicle with walking legs, boat type vehicle, submarine type vehicle, space vehicle, aircraft vehicle); crashworthiness rating; vehicle purpose (e.g., sporting, security, general purpose); manned versus unmanned and so on.

Description Of the Related Art Section Disclaimer: To the extent that specific publications are discussed above in this Background section, these discussions should not be taken as an admission that the discussed publications (e. g., patents) are prior art for patent law purposes. For example, some or all of the discussed publications may not be sufficiently early in time, may not reflect subject matter developed early enough in time and/or may not be sufficiently enabling so as to amount to prior art for patent law purposes.

### SUMMARY OF THE INVENTION

Some embodiments of the present invention relates to battery systems, especially battery systems for BPVs, including LSBPVs. More particularly, the present invention relates to use the use multiple electrochemical cell types (e.g., lead-acid, lithium ion superpolymer) connected so that overvoltage conditions are more reliably prevented by one (or more) of the electrochemical cell type(s), which are chemically structured to receive overvoltage without damage. For example, aqueous lead-acid batteries include lead-acid electrochemical cells that are nor very susceptible to damage from overvoltage. In this example, the aqueous cells are be used to protect lithium ion superpolymer cells from overvoltage conditions. Various aspects of the circuitry structure and/or the chemical aspects of the electrochemical cells can be designed and/or optimized to help accomplish this overvoltage function effectively and reliably.

Some embodiments of the present invention relate to a BPV with interchangeable modules of two or more 1:1 replaceable types, wherein each type of module has a different type, or combination, of electrochemical cells. For example, one battery module type may contain aqueous cells suitable for overvoltage protection and high power operation, while another battery module may include lithium ion superpolymer cells for their large capacity and high energy density.

Some embodiments of the present invention relate to use of lithium ion superpolymer electrochemical cells in low speed battery powered vehicles. There are LSBPV applications that would greatly benefit from the use of lithium ion superpolymer cells and/or combinations of aqueous and non-aqueous electrochemical cells.

Various embodiments of the present invention may exhibit one or more of the following objects, features and/or advantages:

(1) increased driving range, especially for LSBPVs;

(2) maintains or increases in vehicle power, especially in LSBPVs;

(3) decreases or eliminates the probability of battery overvoltage and associated battery damage;

(4) interchangeable and/or 1:1 replaceable battery modules promote ease of battery replacement (e.g., by vehicle user) and simplification of product inventory and distribution;

(5) allows use of pre-existing LSBPV or BPV electronics (e.g., electronics designed for lead-acid battery only BPVs) and associated cost, inventory, marketing advantages; and

(6) simplified construction (relative to other multiple electrochemical cell type BPVs) decreases BPV cost and/or increases durability.

### BRIEF DESCRIPTION OF THE DRAWINGS

FIG. 1 is a schematic of a prior art battery system;

FIG. 2 is a schematic of a first embodiment of a battery system according to the present invention;

FIG. 3 is a graph showing charge and discharge points according to the present invention; and

FIG. 4 is a schematic of a second embodiment of a battery system according to the present invention;

FIG. 5 is a top view of a first embodiment of an LSBPV according to the present invention; and

FIGS. 6 to 10 are handwritten notes and graphs related to overvoltage protection in various battery energy storage systems according to the present invention.

### DETAILED DESCRIPTION OF SOME EMBODIMENTS

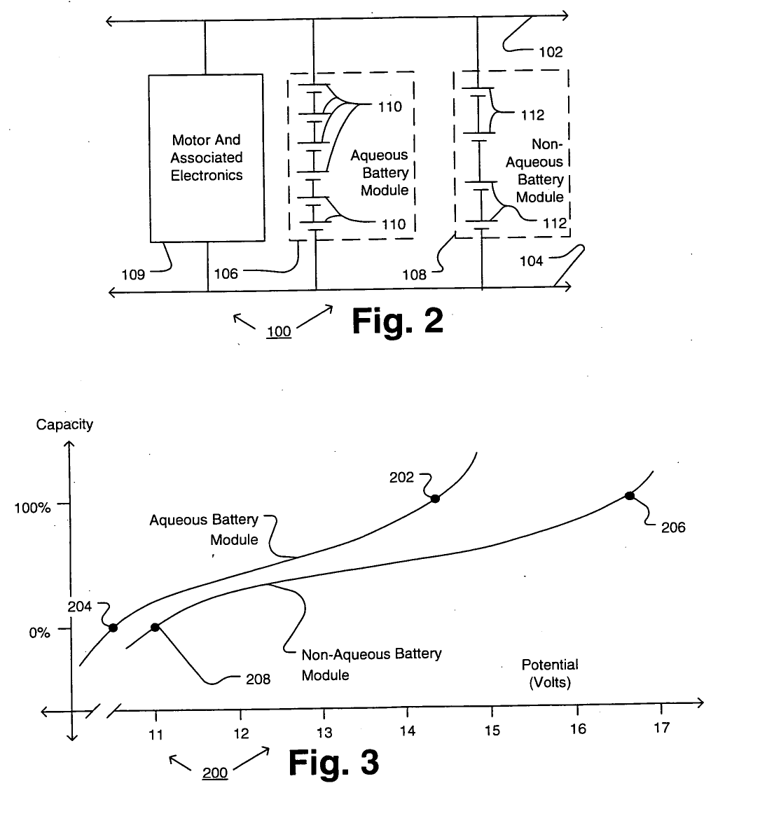

FIG. 2 is a first embodiment of power storage circuitry 100 for storing electrical power used to drive an electric driving motor of a battery powered vehicle (“BPV”). Preferably, the BPV has no need for an internal combustion engine or fuel cell or other on-vehicle energy source because it can store sufficient electrical energy in its battery modules. However, the present invention has broader application to internal combustion-battery hybrid vehicles, fuel cell-battery hybrid vehicles and the like. Preferably, the BPV is an LSBPV. That is because: (1) LSBPVs are increasingly popular; (2) LSBPVs are energy efficient, yet convenient for the user, relative to other transport solutions; (3) LSBPVs can be cheaper to make and/or maintain than larger battery powered vehicles; and (4) the electronics included in many conventional LSBPV designs (specifically, the power rails and associated electronics discussed below) are especially compatible with the present invention. However, the present invention has broader application to battery powered vehicles (“BPVs,”see DEFINITIONS section for definition) both larger (e.g., trucks) and smaller (e.g., remote control small toy cars, microvehicles) than LSBPVs.

Power storage circuitry 100 includes positive power rail 102; negative power rail 104; aqueous battery module 106; non-aqueous battery module 108; electric drive motor (and associated electronics) 109. Power rails 102, 104 and electric drive motor (and associated electronics) 109 are preferably of the type now conventional for LSBPVs and therefore needs not be discussed in detail here. It is contemplated that designs for specific motors, motor-associated electronics, power rails and the like will all continue to develop in the future and it is noted that the present invention will have application to these future designs. The motor-associated electronics of motor (and associated electronics) 109 may include ac-dc converter, regulators, regenerative brakes, inductive power transfer electronics and the like. In many preferred embodiments, these electronics will be designed with a predetermined kind of lead-acid battery modules in mind for parallel connection across the power rails. As explained below, the present invention involves design of higher energy density battery modules to effectively replace one or more of the conventional lead-acid battery modules without much need to redesign the electric motor and/or other electronics of the LSBPV. Although not present in this embodiment, additional electronics (e.g., super capacitors) may be connected across the power rails.

As shown in FIG. 2, battery modules 106, 108 are connected across power rails 102, 104 in parallel. Alternative preferred embodiments of the present invention will often additionally include additional battery modules, of the aqueous battery module type 106 and/or the non-aqueous battery module type 108. Embodiment 100 is a fairly simple embodiment with only one of each type of module.

Aqueous battery module 106 includes a 6 lead-acid electrochemical cells 110. Non-aqueous battery module 108 includes four lithium ion superpolymer (specifically LiCoO₂ cathode) electrochemical cells 112 connected in series. Therefore, embodiment 100 includes two different types of battery modules, each having somewhat different electrical properties and chemical make-up (e.g, identity of electroactive substance in the electrodes). In this example, the two types of battery modules have similarities (e.g. charge point, discharge point, nominal voltage) that will be further discussed below. In this example, the two types of battery modules also have dissimilarities (e.g., chemical response to overvoltage condition, energy density) that will be further discussed below.

Matching Battery Modules of Different Types

Because of their mutual, parallel connection across the power rails, the non-aqueous battery module is designed to be at least somewhat similar to the aqueous battery module with respect to charge point (see DEFINITIONS section for definition), discharge point (see DEFINITIONS section for definition) and nominal voltage. At charge point potential, an electrochemical cell is holding substantially all the charge it can safely and reliably store in a rechargeable manner (note: the electrochemical cells used in energy storage system embodiments of the present invention, whether aqueous or non-aqueous, are preferably rechargeable). In other words, at the charge point voltage, an electrochemical cell holds 100% of its capacity. At discharge point potential, an electrochemical cell is holding as little charge as it can safely and reliably store in a rechargeable manner. In other words, at the discharge point voltage, an electrochemical cell holds 0% of its capacity.

The charge and discharge points for modules 106 and 108 will now be calculated to help show the role of charge point and discharge in designing multiple battery module type (e.g., aqueous / non-aqueous) energy storage systems according to the present invention. The lead- acid cells 110 of module 106 each have a charge point 2.39 V (the gassing point) and a discharge point of 1.75 V. Therefore, the 6 lead-acid cell module 106 has a module charge point of 14.34 V (=6 * 2.39 V), a discharge point of 10.5 V (=6 * 1.75 V) and a nominal voltage of about 12V. The lithium ion superpolymer cells 110 of module 108 are LiCoO₂ cathode cells, each having a charge point 4.2 V (point above which physical damage to the cell, for example electrolyte decomposition, becomes possible) and a discharge point of 2.75 V. Therefore, the 4 LiCoO₂ cell module 108 has a module charge point of 16.8 V (=4* 4.2 V), a discharge point of 11 V (=4 * 2.75 V) and a nominal voltage of about 12V. Notice that the charge point for aqueous module, which is not very susceptible to overvoltage damage, is similar to, but somewhat smaller than the charge point for the non-aqueous module, which is highly susceptible to overvoltage damage. The significance of these facts is discussed below.

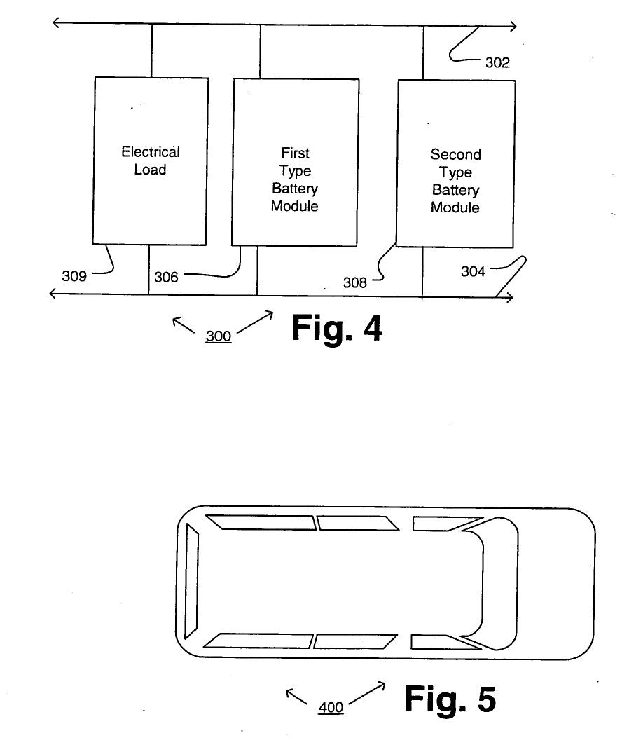

FIG. 3 is a graph 200 showing battery voltage versus relative capacity for the aqueous battery module and the non-aqueous battery module, including aqueous battery charge point 202, aqueous battery discharge point 204, non-aqueous battery charge point 206 and non-aqueous battery discharge point 208. Charge point 202 (=14.34 V at 100% capacity) and charge point 206 (=16.8 V at 100% capacity) are similar in value. Also, discharge point 204 (=10.5 V at 0% capacity) and discharge point 208 (=11 V at 0% capacity) are similar in value. These similarities mean that the two battery modules have a similar nominal voltage of about 12 V and this facilitates the direct connection of both modules across the power rails without large disparities in potential over at least most of the range of their respective capacities.

The similarity in charge, discharge and nominal voltage values was designed by adjusting the number of electrochemical cells in the energy battery module, the electrical characteristics of the energy battery electrochemical cells, the number of electrochemical cells in the power battery module, and/or the electrical characteristics of the power battery electrochemical cells. Generally, the electrical characteristics of the energy electrochemical cells are determined primarily by the electroactive materials used in the electrodes of the cells. Often the designer will have limited flexibility in choosing the electroactive materials (and associated electrochemical characteristics) because this choice is often driven by other considerations, such as maximizing energy density and capacity of the energy battery. Also, the electrical characteristics and/or number of cells 110 of the power battery module is often set by pre-existing LSBPV design.

For example, lithium ion superpolymer electrochemical cells (see DEFINITIONS section for a definition) 112 use carbon as the primary anode electroactive material and LiFePO₄ or one of the lithium-cobalt compounds as the primary cathode electroactive material. This electroactive material choices are driven primarily by factors like energy density, shelf life, cycle life, safety, cost and so on. These electroactive materials choices effectively set the charge value for each of cells 112 as 4.2 V and the discharge value as 2.75 V. Once these values are set, the aggregate charge and discharge values for energy battery module 108 can still be adjusted somewhat by setting the number of cells 112 connected in series in the module. In module 108, four cells 112 are used, which lads to the 16.6 V charge point and 10.5 V discharge points calculated above. This is how the energy battery module is designed to be a 1:1 replacement for the (pre-existing design) power battery module.

In addition to the electrical compatibility discussed in the preceding paragraph, the power and energy batteries should preferably share sufficient mechanical compatibility to be physically interchangeable. Such mechanical compatibility preferably includes giving the batteries similar outside dimensions (e.g., length, width, height), or at least similar dimensions to the extent that the same mechanical hardware can be used to physically secure either type of module in the LSBPV.

While the preferred electrochemical cells 112 of the energy battery module are lithium ion superpolymer cathode cells, other kinds of non-aqueous electrochemical cells, now known or to be developed in the future, may be used in the present invention. Also, the construction of the aqueous battery may be other than a lead acid battery. A couple of examples will now be given to suggest the broad variety of battery types that may be used as aqueous and non-aqueous battery modules in the present invention.

For example, assume a pre-existing LSPBV energy storage system uses nickel-cadmium (“Ni-Cad”) aqueous battery modules that have 4 N—Cad electrochemical cells apiece connected in series. The charge point for each Ni—Cad cell is 1.65 V and the discharge point is 0.8 V. This means that each aqueous Ni—Cad module of this embodiment has a module change point of 6.6 V, a module discharge point of 2.4 V and a nominal voltage of about 4.5 V. Now assume that the designer would like to retrofit the LSBPV with one or more high energy density LiFePO₄ lithium ion superpolymer battery modules replacing some of the Ni—Cad module(s) of the pre-existing design. Generally, the designer can determine charge and discharge points to conventional battery constructions (or battery constructions that will become conventional in the future) by reference to technical handbooks, such as the Handbook of Battery design by David Linden (2d or 3d Ed. 1995). The charge point for each LiFePO₄ cell is determined to be 3.4 V and the discharge point for each LiFePO₄ cell is determined to be 2.75 V. Therefore, if the designer chooses each LiFePO₄ replacement battery module to have 2 LiFePO₄ cells in series, the module charge point will be 6.8 V and the module discharge point will be 5.5 V.

This 6.8 V charge point and 5.5 V discharge point have an advantage and a disadvantage, both worth mentioning. The advantage is that the charge point for the non-aqueous, high energy density LiFePO₄ replacement module is very close to, but just a bit greater than the charge point of the aqueous Ni—Cad module being replaced. More particularly, this charge point similarity leads to overvoltage protection advantages that will be more fully explained below.

The disadvantage is that the discharge point of the LiFePO₄ is so much greater than the discharge point of the pre-existing aqueous Ni—Cad module(s). This means that the energy storage system should be designed so that the voltage across the parallel aqueous and non-aqueous modules should be designed to be no lower than the 5.5 V discharge voltage of the LiFePO₄ module, in order to prevent overdischarge related damage to the LiFePO₄ cells of the LiFePO₄ module. Unfortunately, this means that the capacity portion of the remaining Ni—Cad non-aqueous cells that is safely accessible between potentials of 2.4 V discharge point of the Ni—Cad module and the 5.5V discharge point of the more low-potential-sensitive LiFePO₄ battery module cannot be used because bringing the voltage across the parallel connected modules below 5.5 V would tend to hurt the LiFePO₄ cells.

Despite this disadvantage, it should be understood that this Ni—Cad / LiFePO₄ embodiment still may represent an embodiment of the present invention, and may even be preferred for some applications. Also, the disadvantage may be reduced or eliminated in various ways, such as reconfiguring the energy storage system circuitry to allow independent variation of the module voltages and/or selective, independent discharge of the aqueous and non-aqueous modules. Of course, these proposed modifications to the energy storage system circuitry can add expense and complication, and eliminate the simple, efficient parallel connectability which is a feature of many pre-existing LSBPV and BPV energy storage systems. These kinds of countervailing concerns will probably lead to a wide scope of various embodiments according to the present invention as each designer picks and chooses the features disclosed herein to design the optimum energy storage system for a given BPV application.

It is also possible, but not necessarily preferred, to make an energy battery module from more than one type of electrochemical cells (e.g., Li_{1.2}NiMnCoO₂ cells and LiFePO₄ cells). Although the mismatched electrochemical cell type batteries may cause some equalization issues, it is noted that this mixed cell strategy allows the designer greater flexibility in trying to set the charge and/or discharge points of the non-aqueous battery module sufficiently similar to those of the aqueous battery module.

Other types of power battery electrochemical cells 110, other than lead-acid or Ni—Cad, may also be used. Aqueous type power battery module cells 110 are highly preferred because this type of battery tends to facilitate the overvoltage protection feature discussed below. For example, Ni-MH cells are yet another type of aqueous cells that could alternatively be used.

Overcharge Protection

Now the overvoltage protection feature of embodiment 100 will be discussed. Some types of electrochemical cells are damaged by attempted overcharging, while other types of electrochemical cells are not. For example, aqueous cells are usually not damaged by overvoltage conditions (because of a chemical reaction cycle, called gassing, involving H, 0 and H₂O that is well understood by those of skill in the art). On the other hand, lithium ion superpolymer batteries generally can be hurt by overcharging. However, the parallel connection between the aqueous battery module 106 and non-aqueous battery module 108 of embodiment 100 protects the lithium ion superpolymer energy battery cells 112 from overcharging. This is because cells 110 of aqueous battery module 106 will begin its protective chemical reaction cycle at a potential of about 14.34 V. Because of this cycle, voltage will not rise above about 14.34 V and, accordingly, the 16.6 V charge point, calculated above, for the aqueous module will never be reached, even during high energy bursts, such as regenerative braking. The burst will be accommodated by increasing the relative-capacity of the aqueous module (when the system is under 14.34 V) and also by the gassing reaction (at 14.34 V).

In this way, the aqueous battery module provides overvoltage (sometimes herein called overcharge) protection for the non-aqueous battery module. Because the aqueous battery module itself provides overvoltage protection, special additional controllers and/or components designed to prevent overvoltage of the energy battery can be reduced or eliminated entirely. However, some embodiments of the present invention may include controllers designed to prevent overvoltage and overdischarge conditions. For example, the retarder of King could provide additional protection against overvoltage in the context of the present invention. Also, many pre-existing LSBPV energy storage system circuitry includes features or components to prevent overdischarge. As discussed herein, it is an advantage of some embodiments of the present invention that such pre-existing LSBPV electronics and/or controllers can be used in the new designs of the present invention. For example, the overdischarge protection circuitry built into many pre-existing LSBPVs is inexpensive (presumably because it is mass produced) and complements well the overvoltage protection feature of the present invention.

Besides the overvoltage protection feature described above, the lead-acid power battery module can help ensure a sufficient degree of equalization when charging and/or discharging the lithium ion superpolymer cells 112

Although the foregoing embodiments have nominal voltages of less than 20 volts, it is noted that some conventional LSBPV designs are designed to have nominal voltages across their power rails that are significantly greater (e.g., 48 V, 96V). These higher voltage designs are potentially advantageous in that the desired similarity in charge and discharge points will generally be easier to achieve and adjust because the individual cell charge and discharge points are small relative to the aggregate charge and discharge points for the module as a whole. For some LSBPVs, governmental and/or private agencies, such as the U.S. Department of Transportation issue guidelines for certain LSBPVs. It can be advantageous to use the present invention with LSBPVs because the LSBPV will meet government specifications in addition to having the additional advantages the present invention can provide.

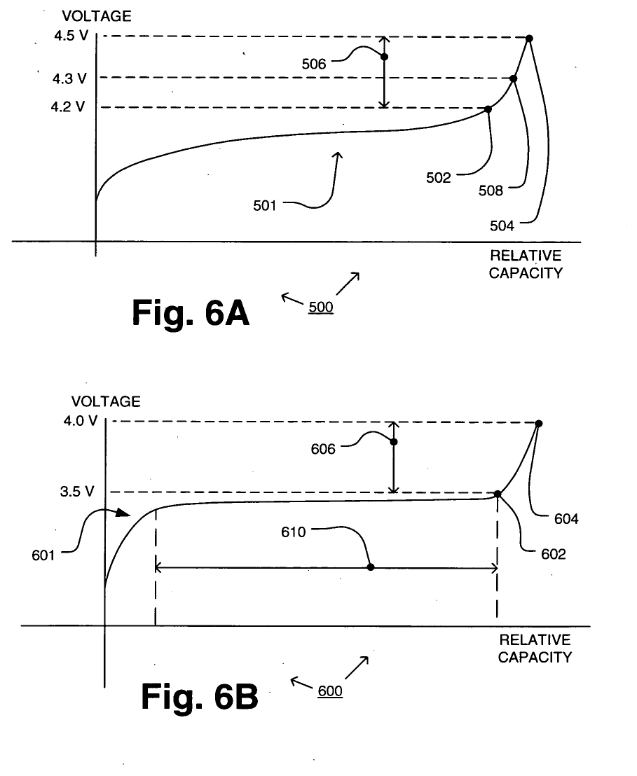

FIG. 4 is a second, illustrated embodiment of power storage circuitry 300 for storing electrical power used to any sort of electrical load (e.g., power for vehicle, utility power type applications, general power storage applications, etc.). Power storage circuitry 300 includes positive power rail 302; negative power rail 304; first type battery module 306; second type battery module 308; and electrical load 309. It is noted that various types of power conditioning, regulation or other processing electronics may be electrically interconnected between the power rails and the load and/or between the power rails in parallel with components 306, 308, 309. Embodiment 300 is more generalized than previously discussed embodiment 100. The first type battery module may be any type of battery capable of supply capable of providing overvoltage protection (preferably an aqueous battery, or a non-aqueous battery that can handle overvoltage conditions without damage). The second type battery may be any type of high capacity battery, the greater the energy density and absolute capacity, generally the better. By having high energy density and capacity, preferred embodiments can use the second type energy module to really extend the effective use of the system between charges. For example when system 300 is used in a BPV, the second type battery module will tend to greatly extend driving range, even in embodiments where the second type battery module can only put out limited power.

Because of the overvoltage protection, even electrochemical cells of types susceptible to overvoltage can be used in the second type battery module. It is noted that the first type module 306 and the second type module 308 each may or may not be included within a single, unitary housing.

As discussed above in connection with embodiment 100, it can be advantageous to (at least approximately) match charge points and/or discharge points between the first type battery module 306 and the second type battery module 308. Generalized design techniques for accomplishing this matching will now be discussed. For purposes of the following discussion it is assumed that the individual electrochemical cells are connected in series both within each module (even though this may not be a necessary connection scheme for all embodiments of the present invention). First, some helpful variables are defined:

FCCP=first type cell charge point (individual cell)

FCDP=first type cell discharge point (individual cell)

SCCP=second type cell charge point (individual cell)

SCDP=second type cell discharge point (individual cell)

NFC=number of electrochemical cells in first type module 306

NSC=number of electrochemical cells in second type module 308

FMCP=first type module charge point (entire module 306)

FMDP=first type cell discharge point (entire module 306)

SMCP=second type cell charge point (entire module 308)

SMDP=second type cell discharge point (entire module 308)

CPD=difference in charge point between modules

DPD=difference in charge point between modules

Next, calculations are made to determine variables CPD and DPD:

(1) FMCP=NFC*FCCP

(2) FMDP=NFC*FCDP

(3) SMCP=NSC*SCCP

(4) SMDP=NSC*SCDP

(5) CPD=SMCP−FMCP

(6) DPD=SMDP−FMDP

Now that CPD and DPD have been calculated, some design preferences can be checked to determine whether the second type battery module likely to work well as a 1:1 replacement for the first type battery module. It is highly preferable that CPD be a positive number. If CPD is negative, then, during battery charging, the energy battery module will fully charge to 100% capacity before the power battery fully charges to 100% capacity. The bad result of this is that the power battery module can no longer provide overvoltage protection for the energy battery module.

Preferably, the capacity of first type battery module 306 should be 5% to 85% of the capacity of second battery module 308. Even more preferably, the capacity of first type battery module 306 should be about 20% of the capacity of second type battery module 308. Although the embodiment 300 of FIG. 4 has only one first type battery module and one second type battery modules, these preferred capacity ranges apply to the aggregate capacities of first type battery modules and/or second type battery modules in embodiments where there are more than one of either or both types of battery modules.

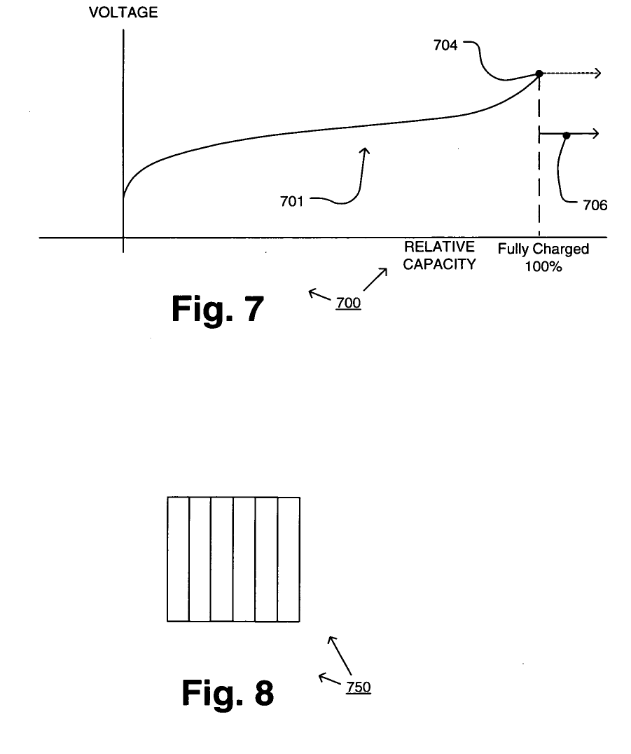

FIG. 5 shows an LSBPV 400 for use with some embodiments of the present invention. In outward appearance, an LSBPV will often look similar to larger vehicles like cars and trucks, but will be much smaller in scale. Other LSBPVs (see DEFINITIONS section) may look dissimilar from cars and trucks (e.g, silent canoes for hunting). According to the present invention, lithium ion superpolymer electrochemical cells are used in LSBPVs (either in combination with other cell types or by themselves).

Charging Buffer Zone

There will now be further discussion of overcharge protection according to the present invention, with attention to the use of a charging buffer zone exhibited by some types of electrochemical cells. Depending on the type of electrochemical cell in the battery, the charging buffer zone (if any) can be beneficially used to design energy storage system where different battery types, with different characteristics, are connected in parallel. Generally speaking, the existence of a charging buffer zone can help match charge points of battery modules. More particularly, charge points of various battery modules can be matched so that: (1) all cells in the system tend to charge up to at least a large proportion of their theoretical capacity (that is, their charge point) during a charging cycle; but (2) the cells still tend to at remain at maximum operating voltages somewhat below the charge point (that is, minimization of existence of overvoltage conditions). For example, non-aqueous cells will generally be damaged by overvoltage, that is electrical potentials greater than the charge point of the non-aqueous cell. However, when a non-aqueous cell has a reasonably large buffer zone, it can be charged up to a very high proportion of its capacity even without being raised up all the way in electrical potential to the voltage of its charge point.

Before proceeding to determination of the non-aqueous battery module charge point and the rest of the refined charge matching technique according to this aspect of the present invention, a few words about the charge point values used in this document are in order. The numerical values for charge points, discharge points and the like are provided for pedagogical purposes and may not accurately reflect actual charge point values of real battery modules and associated cells in the real world. Also, the charge points used in various examples in this document may not even be consistent from example to example. That is because these pedagogical examples are being used to convey the underlying concepts as clearly as possible, rather than to be exact blueprints. Some effort has been made to make the charge point values somewhat realistic, but the inexactness and potential inconsistencies noted in this paragraph should emphasize the fact that actual designers should consult the most applicable (eg, same cell construction, identical electroactive materials, doping, etc.) and up-to-date reference materials when doing actual design work.

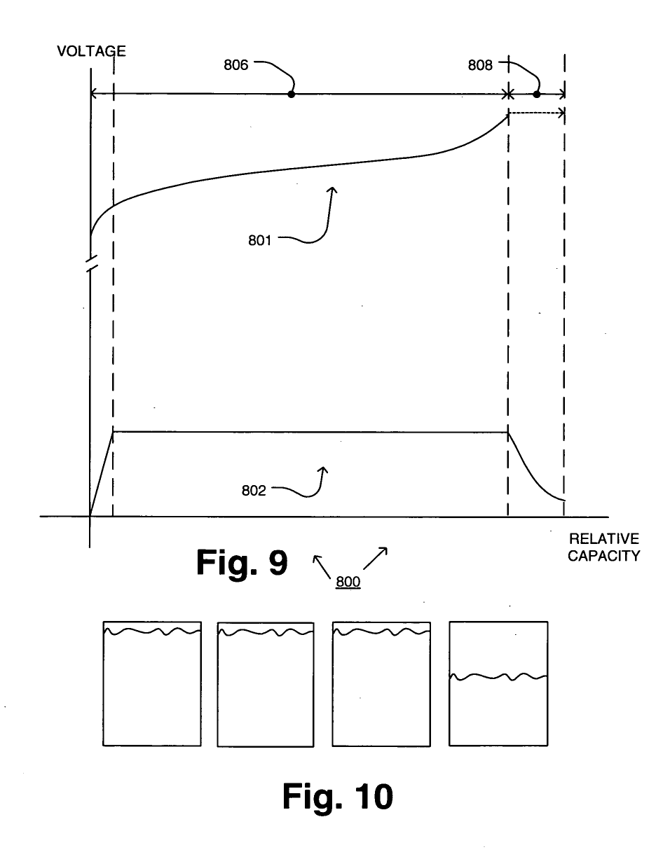

FIG. 6A shows a relative capacity (horizontal axis) versus electrical potential (vertical axis) graph 500 for a lithium ion superpolymer electrochemical cell for use in a LSBPV energy storage system similar to system 100 discussed -above. In this example, the four, series cell 112 non-aqueous module 108 is replaced with a single electrochemical cell of the LiCO₂ cathode (non-aqueous) type. The graph of FIG. 6A shows the charging curve for the single cell, nonaqueous LiCO₂ cathode (non-aqueous) type battery module. In this example, the charge point is 4.5V and the fully charged capacity corresponds to point 504 on the charge curve 501. Above 4.5V, the nonaqueous battery module can experience irreversible solvent breakdown and be permanently damaged.

It is noted, that the relative capacity at point 502 is almost as great as the fully charged capacity at point 504. Despite the fact that the capacity at point 502 is almost as large of the fully charged point 504 capacity, the voltage at point 502 is 4.2V, which is substantially less voltage than the 4.5V of the charge point. This voltage range between 4.2V and 4.5V represents a buffer zone of voltages. It is a relatively large voltage range, but with a relatively small range of associated capacities, as shown by graph 500. If the system can be designed so that the maximum possible system voltage is within this buffer zone (and not above the 4.5V maximum), then the nonaqueous module can effectively be almost fully charged without overcharging, which is a good thing.

Given the graph of FIG. 6A, the designer would look for an aqueous battery module with a charge point in the buffer zone between 4.2V and 4.5V. In this example, assume the designer finds an aqueous battery module with a charge point of 4.3 V. That is, the gassing point of the aqueous module is 4.3V. This would be a good module to use with the nonaqueous module of FIG. 6A because the gassing voltage is indeed in the 4.2V to 4.5V buffer zone. This 4.3 V charge point aqueous battery module would be used as a replacement for module 106 of FIG. 2, in conjunction with the module 108 replacement discussed above to yield a nicely charge-matched system. When the aqueous module gasses at 4.3V, the nonaqueous module will be almost fully charged capacity-wise, and yet will remain safely below the 4.5V charge point at which irreversible damage occurs.

Now that the concept of a buffer zone and charge matching, with reference to a buffer zone, have been discussed in rough terms, discussion will proceed to more refined ways to determine the appropriate precharge point and the associated buffer zone for design purposes. The refined techniques, repeatedly alluded to above, rely on a good determination of the pre-charge point 502 and charging buffer zone 506. However, there is no single, observable, determinative phenomenon that can be effectively used to define the pre-charge point. Before discussing the various methods for determining the pre-charge point, a couple of general observations about typical charge curves will be made. Typical charge curves usually have a long region of shallow voltage increase. This is the flat part of the curve 501 towards the center of its relative capacity range. However, as the relative capacity increases toward the charge point, the voltage begins to rise more and more steeply. The typical non-aqueous charge curve is continuous and smooth, with no real discontinuities between the flat portion and the charge point. Still, one can imagine that there is a sort of comer between the flat portion of the charge curve, and the more steeply vertical portion at voltages just below the charge point. The pre-charge point is located in the vicinity of this “corner”in the curve. The idea is that the shallow relative capacity of the flat zone must be used to ensure that a reasonable proportion of available capacity is used, without exceeding the charge point. In other words, it is desired to set the charge point of the aqueous battery module so that it falls in the charging buffer zone, along the steep vertical part of the charge curve, where the marginal relative capacity is changing very little with marginal voltage increases.

A couple of alternative methods for determining pre-charge point 502 will now be discussed in order: (1) eyeball method; (2) relative capacity threshold method; and (3) calculus method. The eyeball method is simply finding the comer in the curve by rough approximation based on a visual review of the charge curve.

The relative capacity method first sets a lower limit on the relative capacity associated with the pre-charge point. This relative capacity is defined as Z %, where the value of Z is determined by the designer based on how much relative capacity is desired to be used. For example, Z may be chosen as 90%, 99% or 99.9%. Once Z is determined, the voltage level on the charge curve corresponding to Z % relative capacity is then defined as the pre-charge point. Choosing a larger, as opposed to a smaller, value for Z has both potential advantages and potential disadvantages, including the following: (1) the more battery capacity will be used; (2) the closer the pre-charge point will be to the charge point; (3) the smaller the charging buffer zone will be; and (4) the more difficult it will be to find or design an appropriate aqueous module with a charge (i.e., gassing) point within the charging buffer zone. By balancing these advantages and disadvantages (along with any other relevant design concerns), the designer can choose a value for Z then determine a corresponding value for the pre-charge point based on this relative capacity threshold method.

The calculus method chooses a pre-charge point based on the second and third derivatives of charge curve 501. More particularly:
(1) d(voltage) / d(relative capacity) =the first derivative of the charge curve;
(2) d²(voltage) / d(relative capacity)² =the second derivative; and
(3) d³(voltage) / d(relative capacity)³ =the third derivative.
   The charge curve “corner”will be sharpest at the point where: (1) d²(voltage) / d(relative capacity)² is at a local maximum; and (2) d³(voltage) / d(relative capacity)³ is zero. Therefore, under the calculus method, the pre-charge point is selected to be where the second derivative is zero and the third derivative is zero.

By using any of the above-described methods of determining the pre-charge point, the pre-charge point 502 of charge curve 501, assume that the pre-charge point is 4.2 V as stated above. It should be noted that this pre-charge point of 4.2 V is actually quite near the 4.5 charge point, not just in relative capacity (which is a favorable thing), but also in terms of the small 0.3 voltage difference. In this hypothetical, it was lucky that a 4.3 aqueous module could be found within the tight confines of the charging buffer zone.

Even beyond the risk of not being able to make or find an aqueous battery in the narrow charging buffer zone of the LiCO₂ non-aqueous module, there is the additional risk that electrical variations (e.g. manufacturing variations, manufacturing electrical tolerances, temperature variations, current level dependent variations, voltage decreases typical after extensive cycling) could potentially allow overcharge conditions. For example, assume that: (1) the actual non-aqueous module charge point of an actual, manufactured LiCO₂ cell was a bit smaller than 4.5V; and (2) the actual aqueous module charge point of its actual associated aqueous module is a bit more than 4.3 V. In this case, it is easy to see that overvoltage conditions and near occasion of overvoltage conditions would occur.

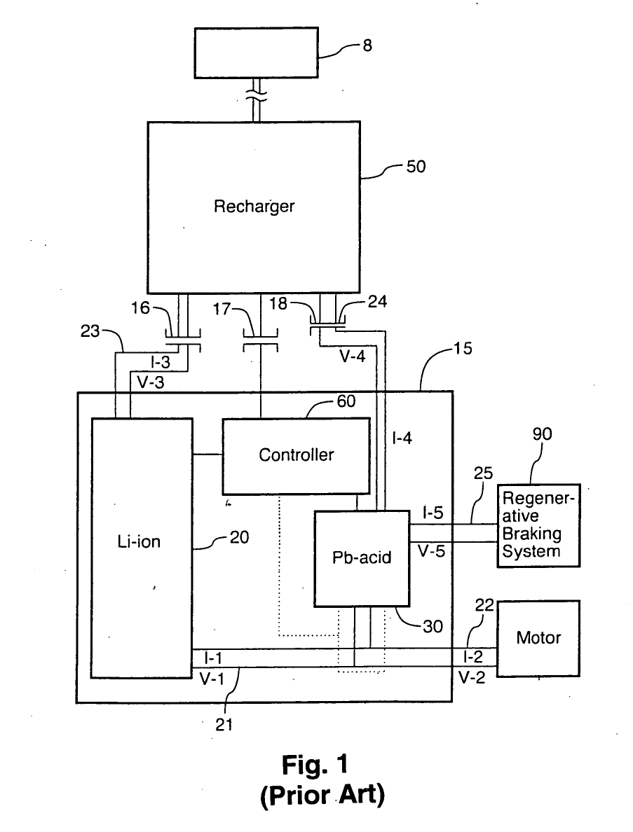

Because of its relatively large pre-charge point and relatively small charging buffer zone, the single cell LiCO₂ construction may not be very amenable to electrochemical prevention of overvoltage conditions by parallel connection of an aqueous module. Even if an aqueous module is present, it may be best to prevent overvoltage (either primarily or redundantly) by electronics (e.g, a controller and its software and hardware) such as controller 60 in prior art FIG. 1. If the LICO₂ battery module were modified to have multiple LiCO₂ connected in series and a correspondingly higher voltage, charge point and pre-charge point, then its charging buffer zone would be wider, and it would be an easier task to design or find a corresponding aqueous module for reliable, chemical (as opposed to electronic) overvoltage protection.

As an example with a wider charging buffer zone, FIG. 6B shows a graph 600 for a single cell LiFePO₄ cathode battery module as the non-aqueous module. Graph 600 includes charge curve 601, pre-charge point 602, charge point 604 and charging buffer zone 606. The relatively wide charging buffer zone (3.5V to 4.0 V) makes selection of a matched aqueous module easier. This is true when dealing with a single cell LiFePO₄ battery module, but even more so when dealing with a multiple cell LiFePO₄ battery module (like module 108).

Charge curve 601 also shows another desirable characteristic of the LiFePO₄ type module: a long charging plateau. More particularly, the charging plateau zone is charging curve's zone of the relatively constant voltage (˜3.4V) with increasing relative capacity. The charging plateau zone typically occurs about midway between charge and discharge point. In a sense, the pre-charge point marks one end of the charging plateau, with the other endpoint occurring in the vicinity of the 0% relative capacity marked by the discharge point. While these charging plateaus are generally present in the charge curves for lithium ion batteries, some charging plateaus are longer and flatter (that is less electrical potential increase over the plateau's run) than others. This can be observed by comparing the charging plateau of curve 501 with the longer, flatter charging plateau 610 of curve 601. It is generally preferable to use a non-aqueous module with a longer and flatter charging curve in the pre-charge point designs of the present invention because it means that the non-aqueous battery will reliably charge to a high relative capacity so long as the companion aqueous modules allow the potential across the power rails to go at least a little above the pre-charge point.

Besides its wide charging buffer zone and long charging plateau zone, the LiFePO₄ construction may include other advantages, such as inexpensiveness and enhanced safety. On the other hand, the various lithium cobalt construction modules may still have other potential advantages, such as greater energy density. Sometimes, for a given LSBPV application, it can be difficult to decide if LiFePO₄ or LiCO₂ is better, on balance, as the non-aqueous module(s). For some applications, it is even feasible and advantageous to include both types of non-aqueous modules, even though this approach is more likely to require a degree of electrical overvoltage protection.

FIG. 7 shows graph 700 for an aqueous, lead-acid battery module. Graph 700 includes charge curve 701, charge point 704 and gassing zone 706. At charge point 704, 100% of the useful, rechargeable capacity of the lead-acid battery module. Beyond charge point 704, the module begins a gassing zone, where a gassing reaction takes place. As is known in the art, in the gassing reaction, water (H₂O) is broken into hydrogen gas (H₂) and oxygen gas (O₂). The additional charge used to feed this gassing reaction past charge point 704, does not represent additional battery capacity. Rather, the gassing reaction merely prevents the voltage across the parallel power rails from rising above the voltage level of charge point 704. As shown in FIG. 7 by a dotted line, the voltage does not rise to the right side of charge point 704 in gassing zone 706.

FIG. 8 shows a schematic of a six cell lead-acid battery module 750. Assuming that the charge point for each lead-acid cell is 3.5V, then the charge point for the 6 cell module is 6×3.5 V =14V. Alternatively, if a 4 cell module were used, then the aggregate charge point would be 4×3.5V =16V. These aqueous charge point module calculations are similar to module 106 and the determination of its charge point 202 discussed in detail above.

FIG. 9 shows graph 800. Graph 800 includes voltage curve 801, current curve 802, constant voltage zone 806 and constant current zone 808. Voltage curve 801 represents the electrical potential across the power rails 102, 104 of system 100. Current curve 802 represents the current flowing in the power rails 102, 104 of system 100. As shown in FIG. 9, constant voltage, constant current control (“CVCC control”) is preferably used in energy storage systems according to the present invention. More particularly, constant current control is used at electrical potential levels below the charge point of the aqueous, lead-acid battery module. Constant voltage control is used at and above this charge point. Advantageously, the gassing reaction that occurs at the charge point of the lead-acid module will effect the constant voltage control, without the need for additional electrical charge control and/or logic. That is because, the gassing reaction will absorb much current (e.g., large currents associated with regenerative braking bursts) without allowing the voltage to rise above the aqueous charge point and, therefore, without damaging any non-aqueous modules connected across the power rails. FIG. 9 also associates the concept of overcharge with trickle charge.

FIG. 10 shows how the present invention helps maintain good charging equalization. The four “buckets” in FIG. 10 each represent a non-aqueous electrochemical cell connected in series in a single, four-cell module. As shown in FIG. 10, the “bucket” on the far right is filling more slowly than the others. This means that this cell, for some reason, is not charging as fast as the other three and has a lower relative capacity. If these fully charged cells were the only control on overvoltage, then an overvoltage condition (and presumably solvent damage) would tend to occur, despite the fact that the slow cell on the right hand side is not yet at full capacity. However, the gassing reaction at the aqueous module, prevents this overvoltage. By preventing the overvoltage, the slow non-aqueous cell on the right hand side is given an extra opportunity to recharge at the voltage level corresponding to the charge (or gassing) point of the aqueous module. This extra charging time for the slow cell(s) is an advantage from the perspective of cell charging equalization.

### CONCLUSION

Many of the above examples, differentiate aqueous and non-aqueous cells. Although this is a useful and simple distinction to make in practice and in everyday conversation, the aqueous / non-aqueous distinction often serves as a rough surrogate for the electrical and chemical characteristics of fundamental interest here. More particularly, the fundamental distinction is of interest is between a module susceptible to damage by overvoltage (generally the non-aqueous module(s)) and modules not susceptible to overvoltage damage (generally the aqueous module(s)). Although non-aqueous batteries unsusceptible to overvoltage damage are not currently common, such batteries may come to be common in the future. Likewise, it is possible that aqueous modules somehow susceptible to overvoltage will be developed in the future. If these possibilities come to pass, it should be kept in mind that the overvoltage characteristics discussed in this paragraph will sometimes be more important than the aqueous / non-aqueous distinction used in pretty much all the above example. Unless a claim explicitly specifies that a module, battery or cell is aqueous (or non-aqueous), such a limitation should not be implied for claim interpretation and scope of the invention purposes.

Many variations on the above-described embodiments of this invention are possible. The fact that a product or process exhibits differences from one or more of the above-described exemplary embodiments does not mean that the product or process is outside the scope (literal scope and/or other legally-recognized scope) of the following claims.

Definitions

The following definitions are provided to facilitate claim interpretation and claim construction:

Present invention: means at least some embodiments of the present invention; references to various feature(s) of the “present invention” throughout this document do not mean that all claimed embodiments or methods include the referenced feature(s).

First, second, third, etc. (“ordinals”): Unless otherwise noted, ordinals only serve to distinguish or identify (e.g., various members of a group); the mere use of ordinals implies neither a consecutive numerical limit nor a serial limitation.

Battery: any device that can output electrical power using one or more electrochemical cells that do not consume fuel; as used herein, battery shall be used to denote a single battery (e.g., a single battery casing) and/or also to refer to a set of batteries collectively; the use of the term “battery” shall not be deemed, in itself, to imply anything about the existence or features of any specific, conventional battery structures or about recharageability; while “battery” is limited to electrochemical cell(s), thereby excluding other electrical power delivery structures like fuel cells and capacitors, the definition of battery is not limited to particular electrochemical cell structures that are currently common or currently known in the art.

Battery module: an electrochemical cell set (however electrically connected or not connected) located at least substantially within a single housing.

Battery powered vehicle (BPV): Any vehicle wherein the energy to propel the vehicle comes at least partially from batteries (see definition of “battery”) electrically connected to drive an electric motor; BPVs may or may not further include other energy providing devices, such as capacitors and fuel cells; BPV may be designed to move through various media, such as over land, on water, underwater and trough outer space.

Charge point: the highest voltage that an electrochemical cell or cell set is designed to handle; for some electrochemical cell types, charge point is defined as when gassing or other non-energy-storage-directed chemical reaction begins to occur (usually the charge point for aqueous electrochemical cells is determined in this way); for other electrochemical cell types, charge point is defined as the largest voltage that can reasonably be maintained across the terminals of the electrochemical cell or cell set without damaging the electrochemical cell(s) (usually the charge point for non-aqueous electrochemical cells is determined in this way).

Discharge point: the lowest voltage that an electrochemical cell or cell set is designed to handle.

Electric motor: any motor actuated by an electrical energy source of any design now known or to be developed in the future; for example, a motor for a conventional electric vehicle, running on electricity from batteries, capacitors and/or fuel cells would be one example of an electric motor.

Electrically interconnected: any structure designed for communicating an electrical signal; the electrical interconnection may take the form of a direct current (dc) path, a capacitive coupling, an inductive coupling a transformer type coupling, other types of electrical coupling and/or combinations of these types of signal paths; the interconnection may be direct or may pass through intermediate electrical and/or non-electrical components; beyond the requirement that an electrical signal be communicated by the electrical interconnection, no limitations are to be implied from the phrase 'electrical interconnection” with respect to the nature, number or proximity of the electrical interconnection.

Electrochemical cell: does not include capacitors or fuel cells.

Electrochemical cell set: one or more electrochemical cells that are in close spatial proximity and/or electrically interconnected.

Low speed battery powered vehicle (LSBPV): Any BPV designed for land travel with a top speed of 25 miles per hour or less.

Lithium ion superpolymer electrochemical cell: Any lithium ion electrochemical cell wherein the electroactive substance of the cathode comprises: (1) lithium and cobalt; and/or (2) LiFePO₄.

Overvoltage condition: when the voltage at any electrochemical cell in a system is at or above its charge point.

“Substantially the same exterior shape and dimensions”: sufficient geometric similarity between two components such that they are 1-1 replaceable for each other in the sense of mechanical fit.

“Substantially similar (charge or discharge point)”: the lesser charge (or discharge) point is no more than 20% less than the greater one.

“Substantially equivalent (charge or discharge point)”: the lesser charge (or discharge) point is no more than 10% less than the greater one.

“Substantially equal (charge or discharge point)”: the lesser charge (or discharge) point is no more than 3% less than the greater one.

To the extent that the definitions provided above are consistent with ordinary, plain, and accustomed meanings (as generally shown by documents such as dictionaries and/or technical lexicons), the above definitions shall be considered controlling and supplemental in nature. To the extent that the definitions provided above are inconsistent with ordinary, plain, and accustomed meanings (as generally shown by documents such as dictionaries and/or technical lexicons), the above definitions shall control. If the definitions provided above are broader than the ordinary, plain, and accustomed meanings in some aspect, then the above definitions shall be considered to broaden the claim accordingly.

To the extent that a patentee may act as its own lexicographer under applicable law, it is hereby further directed that all words appearing in the claims section, except for the above-defined words, shall take on their ordinary, plain, and accustomed meanings (as generally shown by documents such as dictionaries and/or technical lexicons), and shall not be considered to be specially defined in this specification. Notwithstanding this limitation on the inference of “special definitions,” the specification may be used to evidence the appropriate ordinary, plain and accustomed meanings (as generally shown by dictionaries and/or technical lexicons), in the situation where a word or term used in the claims has more than one alternative ordinary, plain and accustomed meaning and the specification is actually helpful in choosing between the alternatives.

What is claimed is:

1. A BPV comprising:
an LSBPV housing;
an LSBPV electric drive system, fixed with respect to the LSBPV housing, structured and located to drive the BPV as an LSBPV; and
a power storage system, fixed with respect to the LSBPV housing, wherein the LSBPV comprises at least one lithium ion superpolymer electrochemical cell.

2. The BPV of claim 1 wherein the LSBPV further comprises at least one aqueous electrochemical cell.

3. The BPV of claim 2 wherein the at least one aqueous electrochemical cell is structured as a lead-acid electrochemical cell.

4. The BPV of claim 1 wherein the BPV is structured according to a set of governmental or private regulations for an LSBPV.

5. The BPV of claim 1 wherein the BPV is a land vehicle.

6. The BPV of claim 5 wherein the BPV has exactly two wheels structured and located to drive the BPV into motion relative to the land by at least substantially rolling contact between the wheels and the land.

7. The BPV of claim 6 wherein the two wheels are at least substantially aligned along an alignment axis defined to lie at least approximately along the direction of travel of the BPV.

8. The BPV of claim 6 wherein the two wheels are at least substantially aligned along an alignment axis defined to lie at least approximately transverse to the direction of travel of the BPV.

9. The BPV of claim 5 wherein the BPV has exactly four wheels structured and located to drive the BPV into motion relative to the land by at least substantially rolling contact between the wheels and the land.

10. The BPV of claim 1 wherein the BPV is designed primarily for recreation.

11. The BPV of claim 1 wherein the BPV is designed primarily for sport.

12. The BPV of claim 1 wherein the BPV is designed primarily for military applications.

13. The BPV of claim 1 wherein the BPV is designed primarily for a person with impaired physical mobility.

14. The BPV of claim 1 wherein the BPV is designed primarily for transportation within one or more of the following types of installations: military base, airport, shopping mall, stadium and/or arena.

15. The BPV of claim 1 wherein the BPV housing is designed to accommodate two human passengers.

16. The BPV of claim 1 wherein the BPV housing is designed to accommodate a maximum of one human passenger.

17. The BPV of claim 1 wherein the BPV housing is designed to accommodate a maximum of zero human passengers.

18. A BPV comprising an energy storage system comprising:
at least one non-aqueous electrochemical cell structured to store electrical energy used, at least in part, to drive the BPV into motion;
at least one aqueous electrochemical cell structured to store electrical energy used, at least in part, to drive the BPV into motion; and
energy storage system circuitry structured to electrically connect the at least one non-aqueous electrochemical cell in parallel with the aqueous electrochemical cell so that the aqueous electrochemical cell will store and/or dissipate at least a portion of the excess electrical energy flowing through the energy storage system during an overvoltage condition.

19. The BPV of claim 18 wherein the aqueous electrochemical cell is structured to dissipate at least a portion of the excess electrical energy flowing through the energy storage system during an overvoltage condition through the chemical mechanism of a chemical cycle involving hydrogen and oxygen.

20. The BPV of claim 18 wherein an aggregate capacity of all aqueous electrochemical cells in the BPV is 5% to 85% of an aggregate capacity of all non-aqueous electrochemical cells in the BPV.

21. The BPV of claim 20 wherein an aggregate capacity of all aqueous electrochemical cells in the BPV is 20% of an aggregate capacity of all non-aqueous electrochemical cells in the BPV.

22. An energy storage system comprising:
a non-aqueous electrochemical cell set, having a first charge point, structured to store electrical energy used, at least in part, to drive the BPV into motion;
an aqueous electrochemical cell set, having a second charge point, structured to store electrical energy used, at least in part, to drive the BPV into motion; and
energy storage system circuitry structured to electrically connect the non-aqueous electrochemical cell set with the aqueous electrochemical cell set;
wherein:
the first charge point is substantially similar to the second charge point; and
the first charge point is greater than or equal to the second charge point so that the aqueous electrochemical cell will store and/or dissipate at least a portion of the excess electrical energy flowing through the energy storage system during an overvoltage condition.

23. The system of claim 22 wherein:
the aqueous electrochemical cell set comprises a plurality of aqueous electrochemical cells connected in series; and
the non-aqueous electrochemical cell set comprises a plurality of aqueous electrochemical cells connected in series.

24. The system of claim 22 wherein energy storage system circuitry is structured to electrically connect the non-aqueous electrochemical cell set with the aqueous electrochemical cell set in parallel.

25. The system of claim 22 wherein the first charge point is substantially equivalent to the second charge point.

26. The system of claim 25 wherein the first charge point is substantially equal to the second charge point.

27. A BPV comprising an energy storage system comprising:
at least one lithium ion superpolymer electrochemical cell structured to store electrical energy used, at least in part, to drive the BPV into motion;
at least one aqueous electrochemical cell structured to store electrical energy used, at least in part, to drive the BPV into motion; and
energy storage system circuitry structured to electrically connect the at least one non-aqueous electrochemical cell in parallel with the aqueous electrochemical cell so that the aqueous electrochemical cell will store and/or dissipate at least a portion of the excess electrical energy flowing through the energy storage system during an overvoltage condition.

28. The BPV of claim 27 wherein the lithium ion superpolymer electrochemical cell set includes at least one LiFePO₄ electrochemical cell.

29. The BPV of claim 27 wherein the lithium ion superpolymer electrochemical cell set includes at least one electrochemical cell comprising lithium and cobalt in at least one of the electrodes.

30. The BPV of claim 27 wherein the aqueous electrochemical cell set includes at least one lead-acid electrochemical cell.

31. An energy storage system comprising:
a non-aqueous battery module comprising:
a non-aqueous electrochemical cell set, having a first charge point, structured to store electrical energy used, at least in part, to drive the BPV into motion; and
a non-aqueous battery module housing dimensioned and structured to house the non-aqueous electrochemical cell set;
an aqueous battery module comprising:
an aqueous electrochemical cell set, having a second charge point, structured to store electrical energy used, at least in part, to drive the BPV into motion; and
an aqueous battery module housing dimensioned and structured to house the non-aqueous electrochemical cell set; and
energy storage system circuitry structured to electrically connect the non-aqueous electrochemical cell set with the aqueous electrochemical cell set.

32. The BPV of claim 31 wherein:
the first charge point is substantially similar to the second charge point; and
the first charge point is greater than or equal to the second charge point so that the aqueous electrochemical cell will store and/or dissipate at least a portion of the excess electrical energy flowing through the energy storage system during an overvoltage condition.

33. The BPV of claim 31 wherein the first discharge point is substantially equivalent to the second discharge point.

34. The BPV of claim 31 wherein:
the aqueous electrochemical cell set comprises a plurality of aqueous electrochemical cells connected in series; and
the non-aqueous electrochemical cell set comprises a plurality of aqueous electrochemical cells connected in series.

35. The BPV of claim 31 wherein energy storage system circuitry is structured to electrically connect the non-aqueous electrochemical cell set with the aqueous electrochemical cell set in parallel.

37. The BPV of claim 31 wherein the non-aqueous electrochemical cell set includes at least one lithium ion superpolymer electrochemical cell.

38. The BPV of claim 31 wherein the aqueous electrochemical cell set includes at least one lead-acid electrochemical cell.

39. The BPV of claim 31 wherein the BPV is structured as an LSBPV.

40. The BPV of claim 31 wherein the non-aqueous battery module housing and the aqueous battery module housing are dimensioned to have substantially the same exterior shape and dimensions.

41. A retrofit BPV design method comprising the following steps:
identifying a pre-existing BPV design wherein the BPV comprises a plurality of aqueous electrochemical cell sets, with all electrochemical cell sets of the pre-existing BPV design having only aqueous electrochemical cells;
removing at least one aqueous electrochemical cell set from the BPV; and
replacing the removed aqueous electrochemical cell set with a non-aqueous electrochemical cell set without substantial modifications to any control electronics and/or circuitry of the BPV.

42. The method of claim 41 wherein:
the removed aqueous electrochemical cell set is housed within an aqueous battery module housing dimensioned and structured to house the removed aqueous electrochemical cell set so that the aqueous battery module housing is removed from the BPV with the removed aqueous electrochemical cell set at the removing step;
the replacement non-aqueous electrochemical cell set is housed within a non-aqueous battery module housing dimensioned and structured to house the non-aqueous electrochemical cell set so that the non-aqueous battery module housing is replaced into the BPV with the replacement non-aqueous electrochemical cell set at the replacing step;
the non-aqueous battery module housing and the aqueous battery module housing are dimensioned to have substantially the same exterior shape and dimensions.

43. The method of claim 41 further comprising the step of selecting the non-aqueous electrochemical cell set so that the removed aqueous electrochemical cell set and the replacement non-aqueous electrochemical cell set have approximately the same charge points.

44. The method of claim 41 wherein the BPV is an LSBPV.

45. A BPV comprising an energy storage system comprising:
a first battery module structured to store electrical energy used, at least in part, to drive the BPV into motion, with the first module being characterized by a first pre-charge point and a first charge point;
a second battery module structured to store electrical energy used, at least in part, to drive the BPV into motion, with the second module being characterized by a second charge point, with the second charge point being greater than the first pre-charge point, and with the second charge point being less than the first charge point; and
energy storage system circuitry structured to electrically connect the at least one non-aqueous battery module in parallel with the aqueous battery module.

46. The BPV of claim 45 wherein:
the first module is an aqueous electrochemical cell type module; and
the second module is a non-aqueous electrochemical cell type module.

47. The BPV of claim 45 wherein the first pre-charge point is determined by the eyeball method.

48. The BPV of claim 45 wherein the first pre-charge point is determined by the calculus method.

49. The BPV of claim 45 wherein the first pre-charge point is determined by the relative capacity threshold method.

50. The BPV of claim 45 wherein the relative capacity defining the first pre-charge point is approximately 90%.

51. The BPV of claim 45 wherein the relative capacity defining the first pre-charge point is approximately 99%.

52. The BPV of claim 45 wherein the relative capacity defining the first pre-charge point is approximately 99.9%.
